(19) United States
(12) Patent Application Publication
(10) Pub. No.: US 2018/0115880 A1
(43) Pub. Date: Apr. 26, 2018

(54) COMMUNICATIONS SYSTEM

(71) Applicant: 24-7 Assistance Pty Ltd, Tugun (AU)

(72) Inventors: Glenn McKay, Broadbeach (AU); Michael Smith, 18 Royston Street (AU); Brian MacDonald, Brookfield (AU)

(73) Assignee: 24-7 Assistance Pty Ltd, Tugun (AU)

(21) Appl. No.: 15/700,835

(22) Filed: Sep. 11, 2017

(30) Foreign Application Priority Data
Oct. 21, 2016 (AU) 2016904280
Nov. 11, 2016 (AU) 2016904603

(51) Int. Cl. H04W 4/22; G08B 21/10

(52) U.S. Cl. CPC H04W 4/22; H04W 52/0261; G08B 21/10

(57) ABSTRACT

The present invention relates to a misfortune alarm system. The system includes a monitoring station. The monitoring station is configured to allocate a misfortune location based on a misfortune and monitor a hand-held communications device. The monitoring station generates an alarm when the monitored device is located proximal to the misfortune location. The present invention also relates to a travel insurance method involving monitoring a hand-held communications device and determining that the monitored device is located in a foreign jurisdiction. A need for travel insurance is determined responsive to the device being located in the foreign jurisdiction.

### TECHNICAL FIELD

The present invention generally relates to a communications system. In particular, the present invention generally relates to a medical-incident response-vehicle system. The present invention has particular, although not exclusive application to deploying response-vehicles to Australian travelers in foreign countries that are encountering medical-incidents.

### BACKGROUND

The reference to any prior art in this specification is not, and should not be taken as an acknowledgement or any form of suggestion that the prior art forms part of the common general knowledge.

Australians are widely travelled owing in part to our multicultural society and isolated geographic location. Perhaps owing to our isolation, many Australians do not speak a foreign language and are at a distinct disadvantage during misfortune incidents in countries where English is not the native language. In the event of medical incidents in such countries, the consequences of miscommunication can be dire.

During a medical emergency, a travelling Australian must firstly summon an emergency services vehicle (e.g. ambulance), which can prove difficult not only owing to the language barrier, but owing to the scarcity of such government vehicles in developing countries and especially in remote locations.

It is uncommon for foreign paramedics to speak English, and therefore vital information from a patient is often miscommunicated, or not communicated at all, to the paramedic. Furthermore, a similar situation later awaits the Australian patient as foreign hospital staff, including doctors, often have difficulty communicating with the patient. Furthermore, the patient may no longer be conscious by the time the hospital is reached even if someone on staff speaks English.

The preferred embodiment provides improvements in deploying response-vehicles to Australian travelers in foreign countries that are encountering medical-incidents. The preferred embodiment is also useful for domestic applications.

### SUMMARY OF THE INVENTION

According to one aspect of the present invention, there is provided a misfortune alarm system including a monitoring station, the monitoring station configured to:

allocate a misfortune location based on a misfortune;

monitor a hand-held communications device; and

generate an alarm when the monitored device is located proximal to the misfortune location.

The monitoring station may receive an indication of device battery life from the device. The monitoring station may display the indication. The monitoring station may put the device to sleep to save on battery life. The monitoring station may periodically wake-up the device to obtain the geographic location of the device.

The misfortune may include a natural disaster, regional disease outbreak or medical incident.

According to another aspect of the present invention, there is provided a misfortune alarm method including:

allocating an misfortune location based on a misfortune;

monitoring a hand-held communications device; and

generating an alarm when the monitored device is located proximal to the misfortune location.

The method may involve deploying assistance to the misfortune location responsive to generating the alarm. The alarm may be sent to the hand-held communications device.

The method may involve receiving an indication of device battery life from the device. The indication may be displayed. The method may involve putting the device to sleep to save on battery life. The method may involve periodically waking-up the device to obtain the geographic location of the device.

The misfortune location may be a geographic area. The alarm may be generated when the device enters the area. The location of the device may be monitored using triangulation, WI-FI or GPS.

The method may involve determining that the monitored device is located in a foreign jurisdiction and notifying the monitored device of travel insurance. The method may further involve purchasing the travel insurance using the device. The purchasing may involve selecting an insurance period.

The method may involve determining that the monitored device is located in a foreign jurisdiction and subscribing to travel insurance whilst in the foreign jurisdiction.

The purchasing may involve determining an insurance period based upon the monitored duration of the device in the foreign jurisdiction. The method may further involve determining the insurance price based upon the foreign jurisdiction. The insurance price may be based upon an alert of the foreign jurisdiction. The method may further include receiving an alert relating to the jurisdiction.

According to another aspect of the present invention, there is provided a travel insurance method involving:

monitoring a hand-held communications device;

determining that the monitored device is located in a foreign jurisdiction; and

determining the need for travel insurance responsive to the device being located in the foreign jurisdiction.

Any of the features described herein can be combined in any combination with any one or more of the other features described herein within the scope of the invention.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic diagram of a medical-incident response-vehicle system according to an embodiment of the present invention;

FIG. 2 is a flowchart showing a medical-incident response method using the system of FIG. 2;

FIG. 3 shows a home screen displayed by a hand-held device of the system of FIG. 1;

FIG. 4 shows an alarm generation screen displayed by a hand-held device of the system of FIG. 1;

FIG. 5 shows an emergency information screen displayed by a hand-held device of the system of FIG. 1;

FIG. 6 shows a subscriber display displayed at a monitoring station of the system of FIG. 1;

FIG. 7 shows a response display displayed at a monitoring station of the system of FIG. 1;

FIG. 8 is a flowchart showing a misfortune alarm method using the system of FIG. 2;

FIG. 9 shows a mobile phone and associated proposal relating to travel insurance;

FIG. 10 shows a mobile phone and another associated proposal relating to travel insurance;

FIG. 11 shows a mobile phone and another associated proposal relating to travel insurance; and

FIG. 12 shows a mobile phone and another associated proposal relating to travel insurance.

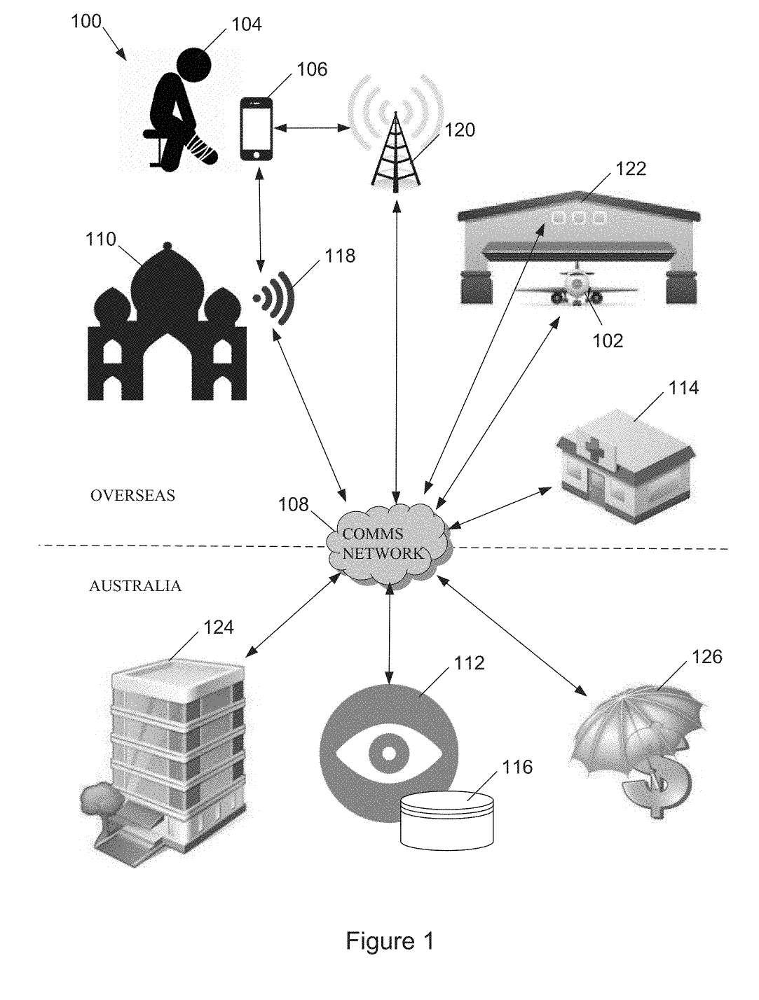

### DETAILED DESCRIPTION OF PREFERRED EMBODIMENTS

According to an embodiment of the present invention, there is provided a medical-incident response-vehicle system 100 for deploying a response vehicle 102 (e.g. land based vehicle or aircraft) to an Australian traveler 104 in a foreign country (e.g. India) that has encountered a medical-incident (e.g. broken ankle).

The system 100 includes a smartphone device 106 (i.e. hand-held communications device) for generating a medical incident alarm to be sent over a data communications network 108 including the Internet. The alarm includes a location of the device 106 determined using a GPS of the device 106, as well as a unique identifier associated with the traveler 104 and device 106.

The system 100 further includes a monitoring station 112 for receiving the medical incident alarm. The incident response vehicle 102, manned by a medical practitioner (e.g. doctor, paramedic, nurse, etc.) is deployed on instructions from the monitoring station 112 and to the location (e.g. Taj Mahal 110 in Agra, Uttar Pradesh, India) of the device 106 to immediately assist the traveler 104.

The traveler 104 is a subscriber to the privately operated system 100. The monitoring station 112 and incident response vehicle 102 may be private commercial entities, although in other embodiments may be government entities (e.g. such as the ambulance service). Advantageously, staff from both the monitoring station 112 and incident response vehicle 102 are bilingual, speaking English to communicate with the subscriber 104 undergoing a medical incident as well as the foreign language of the country (e.g. India) in which the subscriber 104 is located to facilitate communication with hospital staff.

The system 100 includes a medical facility (e.g. hospital) 114 for alerting of: the impending arrival of the response vehicle 102; and pertinent medical information of the subscriber 104 prior to arrival of the response vehicle 102. The medical information includes historical information (e.g. allergies, etc.) and current condition information (e.g. whether or not the subscriber 104 is conscious). Advantageously, the medical facility 114 is given advance warning of the medical incident to reduce critical time otherwise incurred in ascertaining such information at admission to the facility 114.

The monitoring station 112 includes a subscriber database 116 including subscriber records relating to subscribers 104 of the system 100 that may be potentially involved in a medical incident. Each subscriber record includes a matching identifier (sent with the alarm as previously described) to identify the subscriber 104 associated with the device 106, and any medical information of the subscriber (e.g. allergies, current medication, etc.). The subscriber database 116 is stored on a secure server available to only authorized staff of the monitoring station 112.

The system 100 includes a WI-FI hotspot 118 and cellular phone network 120 between the device 106 and the monitoring station 112. A nurse at the monitoring station 112 is able to voice communicate with subscriber 104 using the device 106 (e.g. using voIP) after receipt of the generated incident alarm. The system 100 may also include a satellite communication network (not shown) between the device 106 and the monitoring station 112.

The system 100 further includes a response vehicle station 122 for receiving deployment instructions from the monitoring station 112 upon receipt of the alarm. The subscriber 104 may be an employee of an employer 124 that has sent the subscriber overseas for work purposes. Accordingly, the employer 124 has a duty of care to the subscriber 104. The employer 124 can be reassured that immediate medical attention can be provided to its overseas staff, 24 hours a day and 7 days a week, by subscribing the staff to the system 100. The employer 124 receives electronic medical updates about the subscriber 104 from the monitoring station 112. The system 100 further includes an insurer 126 for approving deployment of the incident response vehicle 102 at the request of the monitoring station 112.

In the present embodiment, the smartphone device 106 includes a software application (i.e. App) to generate the alarm. The App is downloaded from a webserver hosted by the monitoring station 112. The App enables data and voice communications over the network 108, as detailed below.

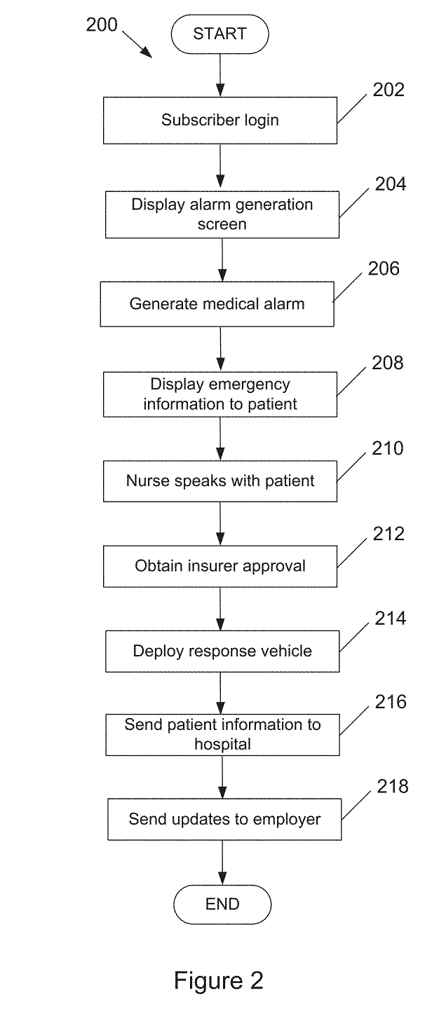

A medical-incident response method 200 using the system 100 is now described with reference to the flowchart in FIG. 2.

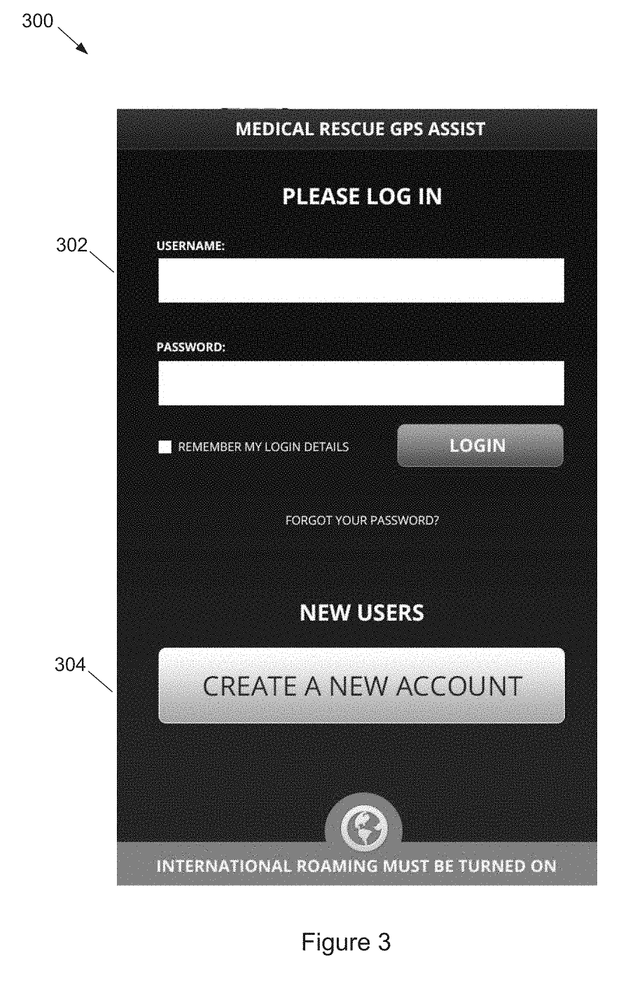

Initially at step 202, the device 106 displays a home screen 300 shown in FIG. 3. The traveler 104 can login using the login prompts 302 if they are already a subscriber of the system 100.

Alternatively, the traveler 104 can create a new account using the new account prompts 304 and subscribe to the system 100. In particular, the device 106 prompts the subscriber to enter subscriber record information including name, password, address, phone number, employer information, travel insurance, health insurance, medical history, medications, allergies, and any other relevant personal information. The completed subscriber record is saved in the subscriber database 116. Further, a unique identifier is allocated to the subscriber 104 and device 106, and stored for matching with the stored record.

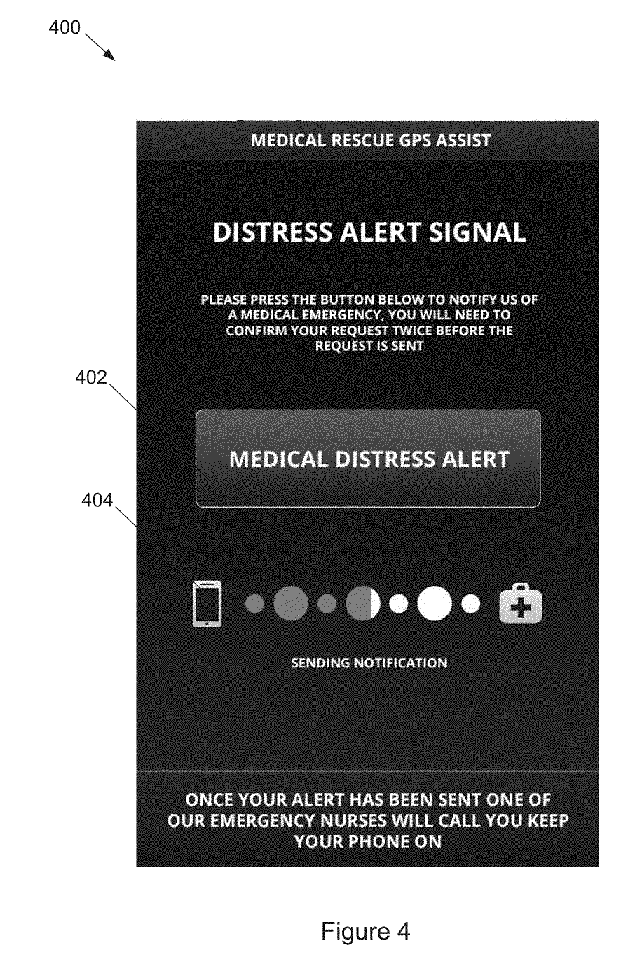

Once logged in at step 204, the device 106 displays an alarm generation screen 400 shown in FIG. 4. The device 106 includes a displayed press-button actuator 402 for enabling the subscriber 104 to generate the alarm upon actuation. The actuator includes a safety mechanism to impede accidental actuation by the subscriber 104. In particular, the safety mechanism includes a receiver for receiving two or more button press inputs of the actuator 402, from the subscriber 104, prior to actuation. The alarm generation screen 400 is typically minimized in the background of the device 106.

At step 206, the subscriber 104 undergoes a medical incident (e.g. broken ankle). Accordingly, the subscriber 104 presses the actuator 402 and the device 106 generates the alarm. The alarm is electronically sent over the network 108. A confirmation receipt indicator 404, in the form of a progress bar, is displayed which confirms when the alarm is received by the monitoring station 112 (via an automated return receipt message sent by the monitoring station 112). The device 106 also places a phone call to the monitoring station 112 upon generation of the alarm.

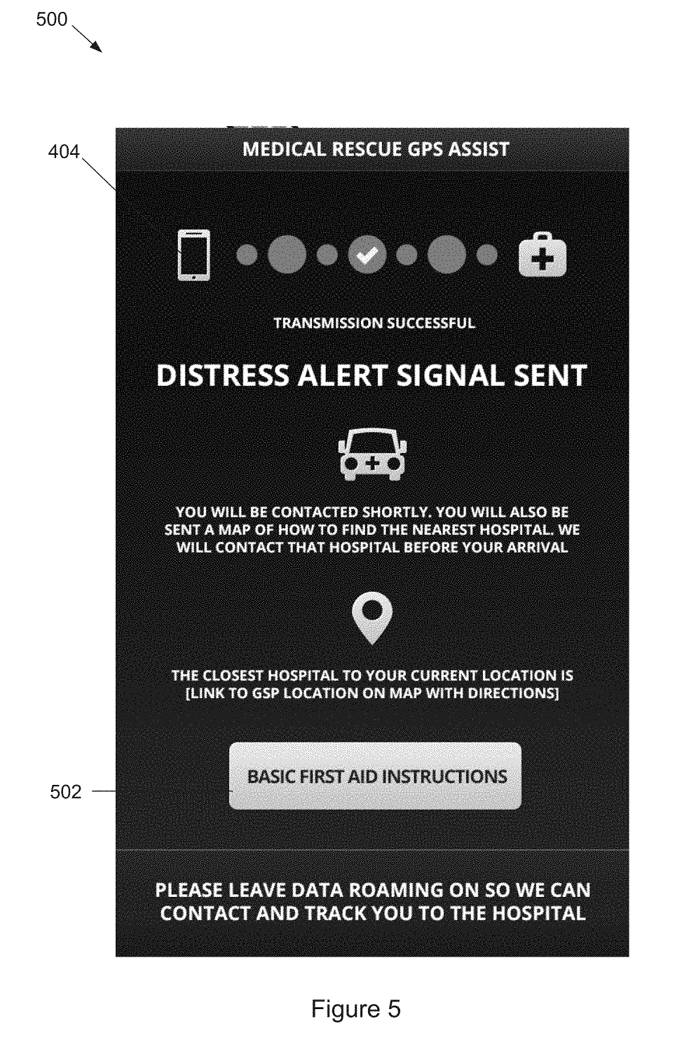

At step 208, the monitoring station 112 electronically receives the generated alarm, and electronically sends the automated receipt. The device 106 then displays the emergency information screen 500 shown in FIG. 5. The receipt indicator 404 is once again displayed showing a completed progress bar. A selectable first aid link 502 is displayed and can be actuated to download a viewable first aid booklet to the device 106. If the call from the device 106 is not received at the monitoring station 112 within a predetermined time from receiving the alarm, the monitoring station automatically generates a notification alerting monitoring station staff to attempt to call the device 106.

The monitoring station 112 also automatically sends a selectable map link (not shown) to the device 106 based upon the known location of the device 106. Upon selection of the map link, the device 106 displays a map showing points of interest to the subscriber 104. The points of interest include nearby medical facilities (e.g. hospital) and emergency services facilities (e.g. police station).

At step 210, a nurse at the monitoring station 112 calls the device 106 and speaks with the subscriber 104 to ascertain the nature of the medical incident and medical condition of the subscriber 104.

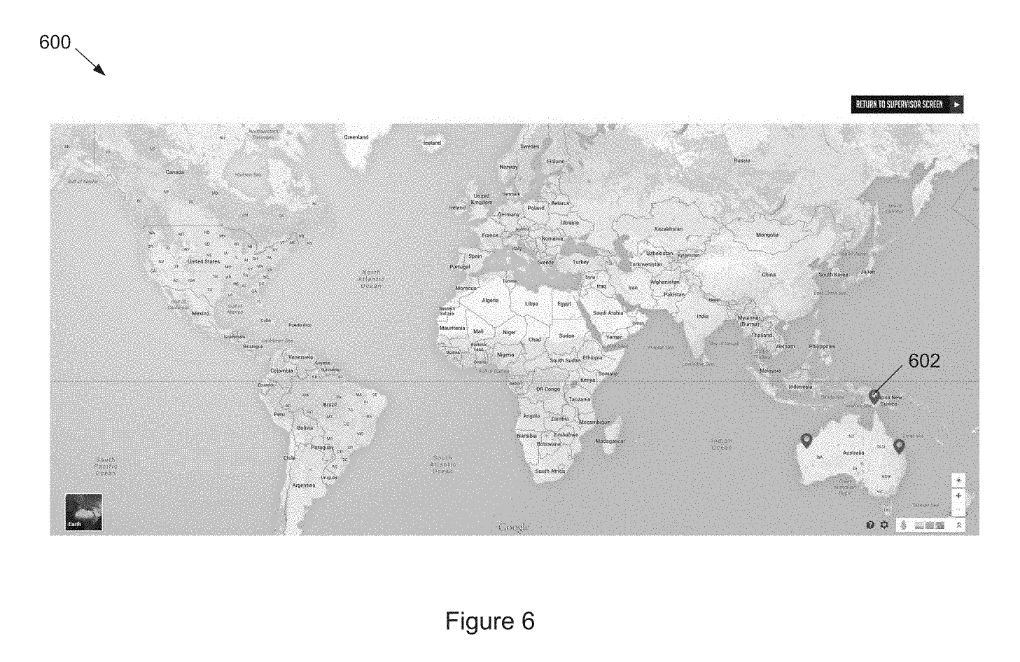

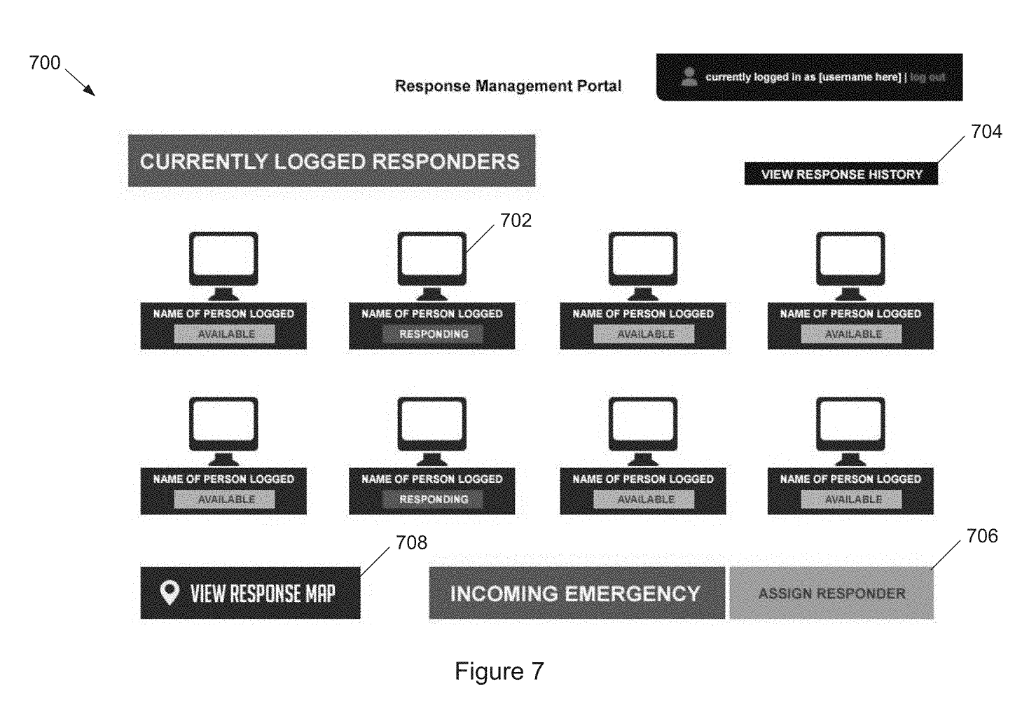

The monitoring station 112 includes two adjacent displays, namely a subscriber display (FIG. 6) for displaying subscriber information and a response display (FIG. 7) for concurrently displaying response information. The adjacent positioning of these displays enables monitoring station staff to effectively co-ordinate the medical-incident response.

Turing to FIG. 6, the subscriber map 600 shows subscriber icons 602 representing the location of logged-in subscriber devices 106, including the device 106 of the subscriber 104 undergoing the present medical incident. The map 600 can also show each medical incident by changing the color of the subscriber icon 602 on the map 600. Further, the icons 602 can be distinguished based upon incident status by color (e.g. RED for incident unattended, ORANGE for incident attended, GREEN for no incident etc.).

Turning to FIG. 7, the response screen 700 shows response vehicle icons 702 representing respective logged response vehicles 102 with medical personnel. The vehicle icons 702 can be distinguished based upon vehicle status by color (e.g. RED for responding or attending, GREEN for available, etc.) The response screen 700 includes a history actuator 704 for viewing the response history; an assignment actuator 706 for assigning an available vehicle to a medical incident; a map actuator 708 for displaying a map (similar to map 600) showing the location of the response vehicles 102 (obtained from GPS messages sent to the monitoring station 112 from the vehicles), and which can also be displayed on map 600.

The staff at the monitoring station 112 can readily use the adjacent displays to select a suitable available response vehicle 102 to attend the injured subscriber 104 based upon criteria including proximity and vehicle attendant skills.

At step 212, the monitoring station 112 electronically sends a request for approving deployment of the suitable response vehicle to the insurer 126 based upon the insurance information stored in the database 116.

At step 214, upon electronic receipt of insurance approval, the monitoring station 112 electronically sends instructions for the response vehicle station 122 to deploy the vehicle 102 to attend the subscriber 104, and does so immediately.

At step 216, the monitoring station 112 electronically sends the medical facility 114 details of the impending arrival of the deployed response vehicle 102, and pertinent information (e.g. current medical condition, allergies, medications, etc.) of the subscriber 104 including information from the subscriber record in the database 116. Advantageously, hospital staff is in possession of the subscriber's pertinent medical record or file. The monitoring station nurse can talk with hospital staff in their native language to ensure that the best possible care is given to the arriving subscriber 104.

The monitoring station 112 can communicate with the patient 104 and staff of the vehicle 102 during transportation to receive updates on the status of the patient 104, which is of great advantage should the patient 104 later fall unconscious. In turn, these updates can be communicated to the hospital 114 in the native language.

At step 218, monitoring station 112 electronically sends medical updates of the subscriber 104 to the employer 124 based upon the employer information stored in the database 116.

Advantageously, the foregoing medical-incident response method 200 is greatly improved when compared with existing prior art response methods. The method 200 reduces delay for any medical incident by at least 10 man hours.

In the event of a misfortune, such as a natural disaster or regional disease outbreak, the monitoring station 112 can be configured to allocate a related geographic misfortune location based on the misfortune, and monitor the moving location of the recreational traveler's smartphone device 106 relative to the misfortune location. The monitoring station 112 generates an alarm when the monitored device 106 is located proximal to the misfortune location.

The monitoring station 112 also receives an indication of device battery life from the device 106 and displays the indication. If power is low, the monitoring station 112 can put the device 106 to sleep to save on battery life. Over time, the monitoring station 112 periodically wakes-up the device to obtain the geographic location of the moving device 112.

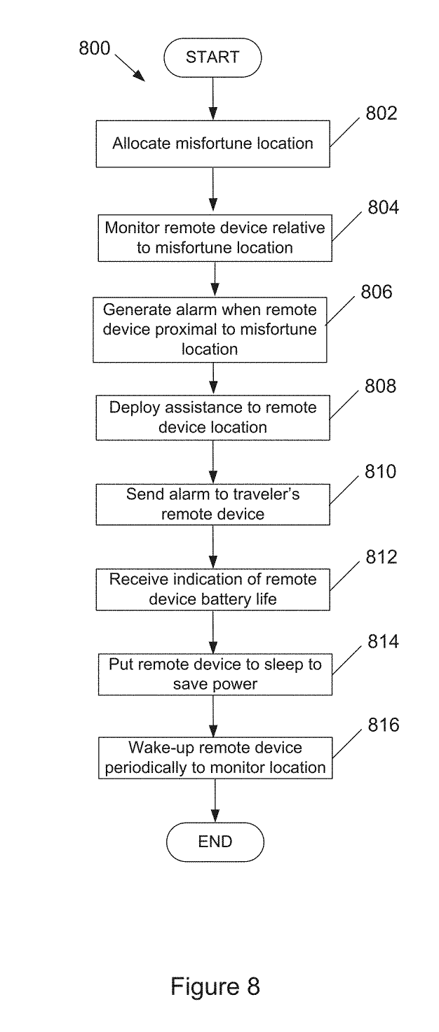

A misfortune alarm method 800 is now described with reference to FIG. 8.

Initially at step 802, the monitoring station 112 is made aware of a regional disease outbreak and allocates an associated misfortune location based on the misfortune. The misfortune location is a geographic area, defined by geographic coo-ordinates, such as a region of a city or state affected by the misfortune.

At step 804, the monitoring station 112 monitors the traveler's device 106 relative to the misfortune location. The location of the device 106 can be monitored using triangulation, WI-FI or GPS.

At step 806, the monitoring station 112 generates an alarm when the monitored device 106 is located proximal to the misfortune location. In particular, the alarm is generated when the device 106 enters the geographic area.

At step 808, the monitoring station 112 can deploy vehicular assistance, as before, to the location of the device 106 or misfortune location responsive to generating the alarm. Assistance may not need to be deployed, depending upon the severity of the misfortune.

At step 810, the monitoring station 112 sends the alarm to the device 106 to warn the traveler of the misfortune. Details of the misfortune are also sent. In this manner, the traveler can leave the misfortune location.

At step 812, the monitoring station 112 receives an indication of device battery life from the device 106. The indication is displayed for assessment by an operator.

At step 814, the monitoring station 112, either automatically or manually, puts the device 106 to sleep to save on battery life, particularly if the device battery is low.

At step 816, the monitoring station 112, either automatically or manually, periodically wakes-up the device 106 to obtain the geographic location of the device 106 until help arrives or the traveler is clear of the misfortune location and safe once more.

A person skilled in the art will appreciate that many embodiments and variations can be made without departing from the ambit of the present invention.

For example, network 108 can include a cellular phone network and public switch telephone network (PSTN). The electronic communications between the entities in the network 108 can be made via any of voice, facsimile, e-mail, SMS or other like messaging and the skilled person will appreciate that appropriate hardware is required to this end. In one embodiment, various communications may not be electronic.

The system 100 can further include another response vehicle (e.g. automobile in the form of an ambulance) for coordinating with the aircraft response vehicle 102. The skilled person will understand that the location of the patient 104 need not be a pinpoint location, but rather a general geographic area or region (e.g. city) and that staff in the vehicle 102 can stretcher the patient 104 to the vehicle 104 as required.

In one embodiment, the system 100 determines that the monitored device 106 is located overseas (i.e. in a foreign jurisdiction when compared with the home account of the device 106) and notifies the monitored device 106 of an offer for travel insurance. The system 100 calculates the insurance price based upon the jurisdiction travel alerts whereby low alert jurisdictions (e.g. Italy) attract a lower premium than high alert jurisdictions subject to travel warnings (e.g. Turkey).

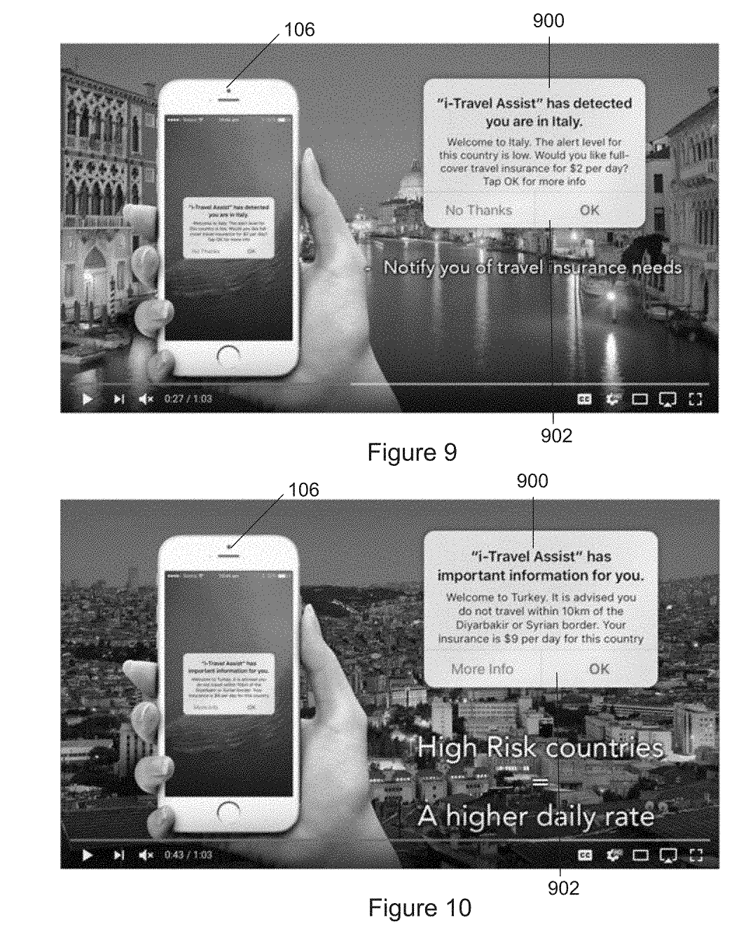

For example, as shown in FIG. 9, the monitored device 106 in Italy receives a proposal 900 to purchase travel insurance at a specified lower rate per day (e.g. $2). The user 104 can then instantaneously purchase travel insurance online using the device 106 by accepting the displayed proposal using the selector 902.

Turning now to FIG. 10, the system 100 detects that the device 106 is in Turkey and sends an update on security alert information for that jurisdiction. In particular, the update warns the traveler 104 to stay away from the Syrian border which is a war zone. In addition, a new revised proposal 900 is received in accordance with the higher alert of the Turkey jurisdiction to increase the insurance premium at a higher rate per day (e.g. $9).

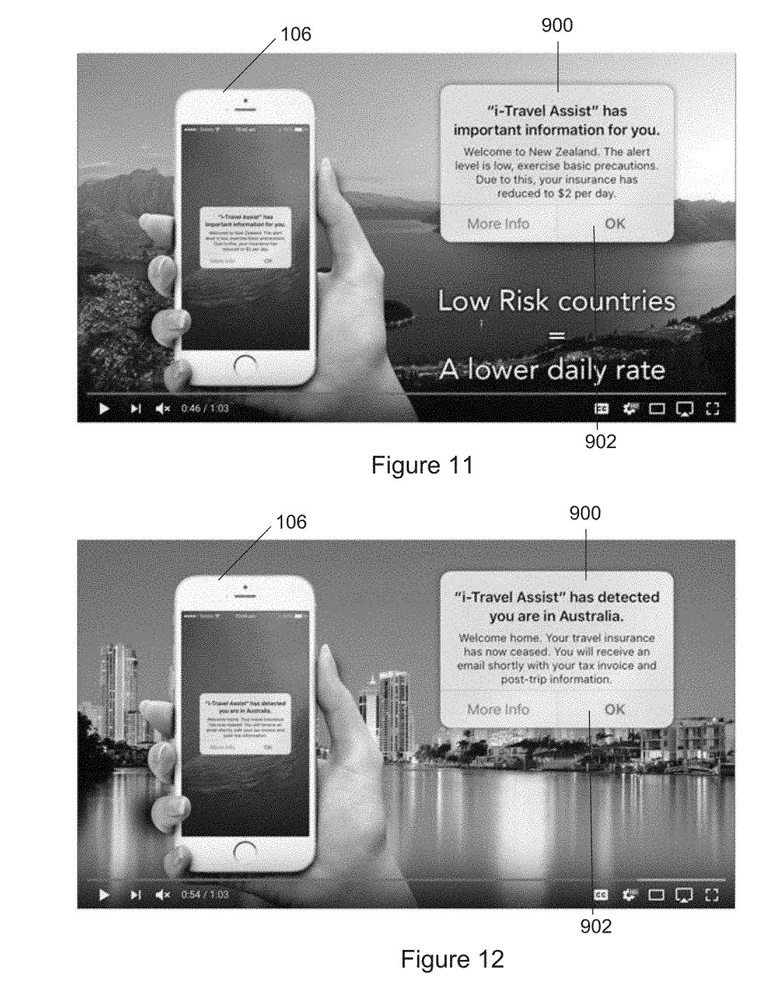

Turning now to FIG. 11, the system 100 detects that the device 106 is in New Zealand and sends an update on security alert information for that jurisdiction. In particular, the update advises the traveler 104 that the alert level is low and only basic safety precautions are required. In addition, a new revised proposal 900 is received in accordance with the lower alert of the New Zealand jurisdiction to decrease the insurance premium at a lower rate per day (e.g. $2).

Turning now to FIG. 12, the system 100 detects that the device 106 is in the home country of Australia and that travel insurance is no longer required. Accordingly, the system 100 prompts the traveler 104 to finalize an invoice and e-mail it to the traveler 104.

Advantageously, the foregoing embodiment provides tailored insurance which is readily verifiable by the device 106. The price of insurance advantageously depends upon the jurisdictions in which the traveler 104 is travelling. In this manner, the traveler 104 only pays for jurisdictions in which they are travelling and for the duration which they travel in those jurisdictions. There is simply no need to pay for jurisdictions in which insurance is not required and for days that the traveler 104 is not actually travelling.

In one embodiment, the electronic purchase involves selecting an insurance period for which the user 104 intends to remain overseas.

In another embodiment, the system 100 determines the need for travel insurance by the user 104 responsive to the device 106 being located in the foreign jurisdiction. In this event, the system 100 automatically subscribes the user 104 to travel insurance whilst the device 104 remains in the in the foreign jurisdiction. Initially, the insurance policy is automatically established when the system 100 detects the location of the device 106 in the foreign jurisdiction. The insurance policy is automatically terminated when the system 100 detects the location of the device 106 in the home country once more.

In compliance with the statute, the invention has been described in language more or less specific to structural or methodical features. It is to be understood that the invention is not limited to specific features shown or described since the means herein described comprises preferred forms of putting the invention into effect.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

1. A misfortune alarm system, comprising:
a monitoring station configured to:
allocate a misfortune location based on a misfortune;
monitor a hand-held communications device; and
generate an alarm when the monitored device is located proximal to the misfortune location.

2. The misfortune alarm system as claimed in claim 1, wherein the monitoring station receives an indication of device battery life from the hand-held communications device.

3. The misfortune alarm system as claimed in claim 1, wherein the monitoring station puts the hand-held communications device to sleep to save on battery life.

4. The misfortune alarm system as claimed in claim 1, wherein the monitoring station periodically wakes-up the hand-held communications device to obtain the geographic location of the hand-held communications device.

5. The misfortune alarm system as claimed in claim 1, wherein the misfortune includes a natural disaster, regional disease outbreak, or medical incident.

6. The misfortune alarm system as claimed in claim 1, further comprising:
the hand-held communications device; and
wherein the monitoring station sends the alarm to the hand-held communications device.

7. The misfortune alarm system as claimed in claim 1, further comprising:
a vehicle; and
wherein the monitoring station deploys the vehicle to the location of the hand-held communications device or misfortune location.

8. A misfortune alarm method, comprising:
allocating a misfortune location based on a misfortune;
monitoring a hand-held communications device; and
generating an alarm when the monitored device is located proximal to the misfortune location.

9. The misfortune alarm method as claimed in claim 8, further comprising deploying assistance to the device location or misfortune location responsive to generating the alarm.

10. The misfortune alarm method as claimed in claim 8, further comprising:
receiving an indication of device battery life from the device;
putting the hand-held communications device to sleep to save on battery life; and
periodically waking-up the hand-held communications device to obtain the geographic location of the hand-held communications device.

11. The misfortune alarm method as claimed in claim 8, wherein the misfortune location is a geographic area and the alarm is generated when the hand-held communications device enters the area.

12. The misfortune alarm method as claimed in claim 11, wherein the location of the hand-held communications device is monitored using triangulation, WI-FI and/or GPS.

13. A travel insurance method, comprising:
monitoring a hand-held communications device;
determining that the monitored device is located in a foreign jurisdiction; and
determining a need for travel insurance responsive to the hand-held communications device being located in the foreign jurisdiction.

14. The travel insurance method as claimed in claim 13, further comprising notifying the monitored device of travel insurance.

15. The travel insurance method as claimed in claim 13, further comprising purchasing the travel insurance using the hand-held communications device.

16. The travel insurance method as claimed in claim 15, wherein the purchasing includes determining an insurance period based upon the monitored duration of the hand-held communications device in the foreign jurisdiction.

17. The travel insurance method as claimed in claim 13, further comprising subscribing to travel insurance whilst in the foreign jurisdiction.

18. The travel insurance method as claimed in claim 13, further comprising determining insurance price based upon the foreign jurisdiction.

19. The travel insurance method as claimed in claim 18, wherein the insurance price is based upon an alert of the foreign jurisdiction.

20. The travel insurance method as claimed in claim 13, further comprising receiving an alert relating to the jurisdiction.
